(19) United States
(12) Patent Application Publication
(10) Pub. No.: US 2014/0198935 A1
(43) Pub. Date: Jul. 17, 2014

(54) Auditory and sensory augmentation and protection system, device and method

(71) Applicants: Jacob Moesgaard, Coopenhagen (DK); Noah Kraft, New York, NY (US)

(72) Inventors: Jacob Moesgaard, Coopenhagen (DK); Noah Kraft, New York, NY (US)

(21) Appl. No.: 13/694,880

(22) Filed: Jan. 15, 2013

(51) Int. Cl. H04R 25/00

(52) U.S. Cl. CPC H04R 25/554
USPC 381/315

(57) ABSTRACT

This invention relates generally to an auditory and sensory augmentation and protection system, device and method to monitor and identify sound and sensory situations, generate data related audio information upon sensing of the sound and sensory situation to provide additional data streams through transmission systems and applications, wristbands, mobile applications and other interfaces, in the form of auditory and sensory augmentation to an individual requesting such augmentation while simultaneously providing protection to the user's hearing in both the sensed sound situation and the auditory augmentation signal.

### COPYRIGHT NOTICE

A portion of the disclosure of this patent document contains material, which is or may be subject to copyright protection. The copyright owner has no objection to the facsimile reproduction by anyone of the patent document or the patent disclosure, as it appears in the Patent and Trademark Office patent file or records, but otherwise reserves all copyright whatsoever in all forms currently known or otherwise developed.

### BACKGROUND OF THE INVENTION

Dealing with noise and loud sounds, coupled with the current trend towards the use of personal sound producing devices and personal electronic devices (PEDs) that concentrate sound and often are played at decibel levels to exclude outside sounds, has caused hearing damage to many individuals at far earlier ages than previously reported. In common use are many types of miniature portable appliances, such as iPods®, smart phones and other personal music devices, which through a helmet, a pair of headphones or ear buds, allow the user to listen to favorite music or programs anywhere and at anytime. Such PEDs have enjoyed great success for several years, but they have the major disadvantage of acoustically isolating the user from the surrounding environment, particularly since a large number of users prefer to listen at a very high volume. Although perfect acoustic isolation allows for listening comfort, such isolation could subject the user to a wide range of hearing loss. Moreover, the accessibility and popularity of these personal music players (PMPs) and PEDs has changed the way many people, especially the younger population, obtain information and generally communicate In a European Commission-sponsored study in 2008, it was determined that most users listen to these devices at levels between 80 and 115 dB. Users will increase listening levels when background noise increases, especially with headphones that do not feature external noise cancellation. In all cases, a background noise of 80 dB (commonly encountered in urban environments) caused users to increase the volume on their devices to dangerous levels.

Hearing damage from common “social noise exposure” has been steadily increasing with noise coming from everyday social environments such as gyms, restaurants, fitness classes and bars. Noise in the street is often exacerbated by the proximity of buildings, which tend to cause the sound to reverberate and surround an individual. Moreover, many individuals attend events, which, by there very nature, are designed to expose the participants to loud noise as part of the entertainment value of the event. NASCAR racing, basketball tournaments, hockey and the like are but a few of the instances where the noise is often a critical part of the ambiance and experience, which the participant wants to enjoy.

Spectators attending live events, such as football games, baseball games, automobile racing, hockey games, etc. do so, in part, to experience the auditory and visual stimulus of the event itself. However, that auditory stimulus can cause damage, both as the result of instantaneous crowd and event noise and cumulative event noise.

Moreover, attendance at the event can cause individuals to feel that they are being deprived of additional information and stimulae that they might otherwise obtain if they were to view the event remotely, such as through a television broadcast. To overcome that perceived deprivation, attendees often carry radio or television devices with them to such events and attempt to listen to the devices in order to obtain external commentary and information while also viewing the event “live.” That has the immediate drawback of requiring the attendee to maintain the audio level of the radio or television at a sufficiently high level so as to be able to hear it over the din of the event and it also may result in lag times and other inconvenient and undesirable side effects. This can impede the enjoyment of the event for others and, if the radio or television is kept near the person's ear—as is common—can damage the hearing of the user.

Noise and harmful exposure to it is also steadily rising with the growth of sports centers (particularly ones that are contained so that the noise tends to reverberate and surround the attendees), or ones where there is a constant level of extreme noise, such as motorcar races. These enclosed spaces have a similar auditory effect to the close proximity of buildings (described above), and the prevalence of unregulated decibel levels at such events has had a huge effect on hearing health today.

The advent of both higher noise levels and the creation of situations where individuals use sound to insulate themselves and hear what they want to hear at a decibel level that excludes otherwise intrusive sound has created a serious public health issue: hearing damage is becoming a major contemporary problem. A MarkeTrack study indicates that hearing loss is up 33% over the past 25 years, with NIHL in adolescents age 14-19 up 30% since 1994 and hearing aid adoption rates—due to hearing loss—of 20-to 39-year olds grew faster than any other groups by far in 2010. While this problem is demonstrable, prevention and treatment are insufficient and efforts to minimize the damage are not properly directed. In short, there is little effort being made to address the issue by minimizing the damaging noise or of otherwise attempting to reduce the hearing loss by reducing overexposure to the noise. Furthermore, efforts to promote hearing health are not being directed to those most effected—the younger age groups

The hearing aid market—while massive—still almost exclusively speaks to the elderly, as there is a massive stigma against adopting hearing aids across all demographics. Hearing loss and hearing research are huge fields, and the development of hearing aids to assist persons with hearing loss achieve greater auditory information spans biomedical research, technology development, audio research, and social, occupational, and environmental research, but the use of hearing devices as auditory data and stimulus augmentation devices for use in connection with events has not gained currency. Moreover, such devices and supplemental systems can have the added benefit of providing auditory protection both by minimizing singular and/or random high decibel auditory impingement through modulation of the impinging audio signal while still maintaining acceptable audio levels for the sensory augmentation signal(s) that the individual chooses to acquire during the event.

Sensorineural hearing loss caused by noise exposure—be it a single traumatic noise event or exposure over a long period time—is called noise-induced hearing loss (NIHL). NIHL is steadily on the rise, and for the first time it represents the most common form of hearing loss across all demographics, with significant growth in youth populations. NIHL is preventable, as it is caused by overexposure to excessively loud noise or excessive duration of listening and it is causing hearing problems on an unprecedented scale, especially among those aged 20-39. NIHL, like all forms of hearing loss, is a permanent hearing impairment. Anatomically, NIHL occurs when intense sound levels enter the ear and damage inner-ear hair cells that respond to sound and stimulate the cochlear nerve. Once damaged, these cells cannot be repaired. This type of hearing damage is becoming a major problem.

Three factors affect NIHL: sound intensity, frequency, and duration. Sound intensity, measured in dBs, is known to cause permanent hearing damage at levels over 85 dB. The prevalence of hearing damage, and lack of protective measures which are acceptable to those who are likely to incur the hearing damage is remarkable, especially when it comes to “social noise exposure.” While regulations such as those drafted by NIOSH and the European Commission have been applied to occupational hearing safety for nearly thirty years, few if any limits are enforced for event or social noise sources, which can be equally bad or, in many cases nowadays, worse.

The American Hearing Research Foundation estimates that more than thirty million Americans are exposed to hazardous sound levels on a regular basis, while People Hearing Better (a leading online community for hearing health) indicates that hearing loss is now the third most common health problem in the nation, due mostly to noise exposure. The numbers generated by the American Hearing Research Foundation most likely do not include those individuals who voluntarily subject themselves to such hazardous sound levels by attending events where those levels are part of the “experience”. Thus, the real number of people exposed is likely to greatly exceed the thirty million number referenced above.

Tinnitus, a hissing or ringing sound in the ears, is another important hearing health condition associated with high-intensity noise exposure, and often accompanies NIHL. The American Hearing Research Foundation estimates that 36 million Americans have some level of tinnitus and cases of tinnitus caused by social noise exposure—noise caused by everyday, social environmental factors—are on the rise.

Event noise such as that found at Olympic games or polo and tennis matches, while potentially damaging to hearing, are overshadowed by event noise at motor car races, motorcycle races and events such as football, soccer, hockey, basketball and baseball games and the like. Similarly, event noise at “sound events” such as concerts, multi-media sound/visual exhibitions, political rallies, and the like have the added problems that the attendee is there precisely to be engulfed and surrounded by the very sound that is injurious to their hearing. Thus, there is the additional need to permit such attendees to enjoy the “sound event” to the fullest, while minimizing the damage to the attendee's hearing as the result of the “sound event”. In both instances, however, there is the added need to permit the attendee to heighten the experience by obtaining additional data of their choosing to augment the visual and auditory data directly being viewed and/or received at the event.

High sound pressure levels or a weighted measure over time so that the aggregate of 100 dBs (dBA?) over 15 minutes of exposure, can cause similar injury. For each 3 dB increase in sound power level above 85 dBs it would be advantageous to reduce the exposure time limit by one half. For a sound power level of P.sub.i in dBs the maximum exposure time could be calculated as:

T.sub.i=8/log.sub.10.sup.−1((P.sub.i−85)/10)hours

or

T.sub.i=8/antilog. sub.10((P.sub.i−85)/10)hours.

If one were to measure the cumulative exposure at all levels above 85 dBs by recording the total time t.sub.i that the sound power level is in each range P.sub.i. then the cumulative exposure dose D relative to a maximum exposure limit of 100% is given by:

D=(t.sub.1/T.sub.1+t.sub.2/T.sub.2+ . . . +t.sub.n/T.sub.n)*100%.

By employing the above calculations, in conjunction with the exposure guidelines for hearing loss prevention released by Occupational health organizations in the EU, as well as OSHA and the National Institute for Occupational Safety and Health (NIOSH) in the USA (see below chart), one can readily see the pressing need for a device which can be used in an event related context to provide additional data signal(s?) which are not harmful in an auditory context and simultaneously provide a protective measure to reduce the event related noise damage.

TABLE
Sound intensity-exposure-damage relationship. Note that for every 3 dB
increase, the sound energy roughly doubles (as the decibel scale is
logarithmic), thereby halving the amount of exposure time before damage.

| dB level | Exposure limit before damage occurs | |
|---|---|---|
| 85 dB | 8 | hours of exposure |
| 88 dB | 4 | hours of exposure |
| 91 dB | 2 | hours of exposure |
| 94 dB | 1 | hour of exposure |
| 97 dB | 30 | minutes of exposure |
| 100 dB | 15 | minutes of exposure |
| 103 dB | ~7 | minutes of exposure |
| 106 dB | ~3 | minutes of exposure |

Source: http://www.cdc.gov/niosh/topics/noise/chart-lookatnoise.html (accessed 9/09/2012)

All of these numbers reveal one certain concept: social and environmental noise easily reaches levels that cause damage to hearing within many social settings, environments and spaces, which allow unregulated decibel levels that cause damage if an individual stays in that space for only a few minutes. The National Institute of Health (www.nih.qov) and National Institute for Occupational Safety and Health (http://www.cdc.gov/niosh/98-126.html) recommend no more than 15 minutes of exposure to high sound power levels above 100 dBs and no more than 8 hours of exposure above 85 dBs. Despite these recommendations and the documented effect, which results from ignoring hearing health warnings that are becoming more and more prevalent both through popular media and official hearing organizations, there is little effort being made to develop and implement a system, which detects the presence of hearing-damaging situations and protects the individual. Moreover, since the effect of noise is cumulative and there is a desensitizing element, which occurs when a person is subjected to hearing-damaging situations, there is a tendency to ignore the effect until it is too late and irreversible. Hearing loss, unlike that of loss of sight, cannot be fixed by something like Lasik surgery. It is permanent.

Technology currently serves to provide “corrective” in-ear devices (colloquially known today as “hearing aids”), which are used after the damage has been done: this technology is reactive, not proactive. There are also specialty products for musicians, industrial uses, and others who use “smart” or specific-purpose earplugs or ear protection devices. These commonly feature either a specifically designed material compound that provides static but custom frequency attenuation (dampening), or contain receivers, reproducers, and digital signal processing units to dynamically shape received sounds according to certain EQ profiles. In most cases these products also require a visit to the audiologistor the like for individual specific ear molding/inner ear scanning. These devices can also incorporate technology that provides feedback data streams to permit the musician to “listen” to what they are recording and to make sure that they are synchronized with other musicians. In certain instances, such in-ear devices can be advantageously employed to permit a musician to record a song, which is synchronized to a pre-existing audio track (the back track), such as where a current singer is creating a multi-singer or multi-instrumental album with others who are not physically present at the recording studio. Such in-ear devices can also be employed to permit speakers to be “prompted” so that they do not forget their lines or are “cued” to speak at a given time. All of these situations are well known and demonstrate the current limited uses for in-ear devices. These uses have not expanded over the years, despite advances in hearing-aid technology.

Modern hearing aids, utilizing modern in ear technology, can help to mitigate at least some of the problems associated with impaired hearing by amplifying ambient sound. These modern hearing aids can receive an input audio signal using an input converter. The audio input signal can in turn be converted into electrical input signals that are routed to a signal-processing unit for further processing and amplification. The further processing and amplification can be used to compensate for the individual loss of hearing of a hearing aid wearer. The signal-processing unit provides an electrical output signal, which is fed via an output converter to the wearer of the hearing aid so the wearer perceives the output signal as an acoustic signal. Earpieces that generate an acoustic output signal are usually used as output converters; however, the use of such earpieces to provide data streams which permit auditory augmentation and concomitant visual augmentation of events have not been employed in connection with such events. There is a need for such implementation and systems to permit their use in “event” circumstances.

Every electronic hearing aid has at minimum a microphone, a loudspeaker (commonly called a receiver), a battery, and electronic circuitry. The electronic circuitry varies among devices, even if they are the same style. The circuitry falls into three categories based on the type of audio processing (Analog or Digital) and the type of control circuitry (Adjustable or Programmable). In one category, the audio circuit is analog having electronic components that can be adjusted. With these types of hearing aids, a hearing professional (such as an audiologist or certified technician) determines the specific gain and other specifications required for the wearer, and then adjusts the analog components either with small controls on the hearing aid itself or by having a laboratory build the hearing aid to meet those specifications. After the adjustment is completed, the resulting audio processing does not change any further, other than possibly overall loudness that the wearer adjusts with a volume control. This type of circuitry is generally the least flexible.

In another category, the audio circuit is analog but with additional electronic control circuitry that can be programmed, sometimes with more than one program. The electronic control circuitry can be fixed during manufacturing or in some cases, the hearing professional can use an external computer temporarily connected to the hearing aid to program the additional control circuitry. The wearer can change the program for different listening environments by pressing buttons either on the device itself or on a remote control or in some cases the additional control circuitry operates automatically. This type of circuitry is generally more flexible than simple adjustable controls.

In yet another category, both the audio circuit and the additional control circuits are fully digital in nature. The hearing professional programs the hearing aid with an external computer temporarily connected to the device and can adjust all processing characteristics on an individual basis. Fully digital hearing aids can be programmed with multiple programs that can be invoked by the wearer, or that operate automatically and adaptively. These programs reduce acoustic feedback (whistling), reduce background noise, detect and automatically accommodate different listening environments (loud vs. soft, speech vs. music, quiet vs. noisy, etc.), control additional components such as multiple microphones to improve spatial hearing, transpose frequencies (shift high frequencies that a wearer may not hear to lower frequency regions where hearing may be better), and implement many other features. In some embodiments, the hearing aid wearer has almost complete control over the settings of most, but not all, settings. For example, in order to prevent unintended harm to the wearer, certain settings (such as gain) can only be changed within a well-defined range. Other settings, such a frequency response, can have more latitude but any allowed changes will nonetheless be restricted in order to prevent any changes to the audio processing that may be harmful to the hearing aid wearer.

Fully digital circuitry can also include wireless hearing aids that allow control over wireless transmission capability for both the audio and the control circuitry. Control signals in a hearing aid on one ear can be sent wirelessly to the control circuitry in the hearing aid on the opposite ear to ensure that the audio in both ears is either matched directly or that the audio contains intentional differences that mimic the differences in normal binaural hearing to preserve spatial hearing ability. Audio signals can be sent wirelessly to and from external devices through a separate module, often a small device worn like a pendant and commonly called a “streamer” that allows wireless connection to yet other external devices. In those embodiments where additional computational resources or sensor resources are required, the external devices can take the form of a portable computing device along the lines of a smart phone, tablet device, and portable media player.

Programmable hearing aids that allow a user to adjust the hearing aid's response to their own preference have been recently made available at lower cost. Using the programmable hearing aid, for example, the frequency response of the hearing aid can be adjusted by the consumer in order to improve the overall user experience by accentuating certain frequencies or range of frequencies. In addition to programmable hearing aids, wireless hearing aids have been developed. For example, for a hearing impaired consumer using two hearing aids, an adjustment to one of the two hearing aids can be transmitted to the other hearing aid such that pressing one hearing aid's program button simultaneously changes the corresponding settings on the other hearing aid such that both hearing aids change settings simultaneously.

Therefore, with the advent of programmable hearing aids whose signal processing can at least be partially modified, what is desired is providing a hearing aid user the ability to modify the audio processing of the programmable hearing aid in the context for which the hearing aid will be used.

In addition to the above, hearing aids today permit, among other things, the following connectivity and auditory enhancements:

Wireless connection to external devices such as TVs, phones, and stereos;

Speech processing and clarifying;

Music/media enhancement profiles and auto-detection;

Noise reduction and adaptive filtering;

Rechargeable batteries; and,

Adaptive or tracking dual locational microphones.

While the list above demonstrates a number of attractive and important technological features of new hearing aids, which permit individuals with hearing impairments to enjoy a wide range of auditory stimulae, there has not been an effort to adapt the hearing aid technology to engage those without current otic issues or otic issues on the severity that would require a traditional “hearing aid” in order to prevent them from becoming impaired or deaf to the extent in which a hearing aid would then be required. Similarly, there has been no effort to adapt the current hearing aid technology to permit event attendees to access data streams that can augment the sensory experience of attending the event, while providing protection both from the event noise and the auditory component of the event augmentation data signals, nor any real effort made to de-stigmatize the negative impression associated with the term “hearing aid.”

The sensitivity of the human ear varies with both frequency and level, a fact well documented in the psychoacoustics literature. One of the results is that the perceived spectrum or timbre of a given sound varies with the acoustic level at which the sound is heard. For example, for a sound containing low, middle and high frequencies, the perceived relative proportions of such frequency components change with the overall loudness of the sound; when it is quiet the low and high frequency components sound quieter relative to the middle frequencies than they sound when it is loud. This phenomenon is well known. Thus, the lower sensitivity of the ear at the frequency extremes is often compensated for by turning up the sound and endangering the ear. In order to provide accurate sound which is acceptable to a “protective” hearing device wearer (colloquially known today as an “ear plug”), it is necessary to ensure that the spectral range remains such that each frequency element does not result in a distortion of the overall perceived signal on the auditory system and cause the wearer to either increase “loudness” or otherwise diminish the protective aspect of the system. It is also important not to diminish the “live” nature of the event by requiring an individual to focus on getting and listening to additional event signals. No device currently exists that achieves all of these goals. Thus, it would be advantageous to permit the additional event signals to be transmitted to a single hearing device, in a controlled and protected manner, to permit the attendee to enjoy both the “live” event and the “augmentation” simultaneously.

### SUMMARY OF THE INVENTION

It is an object of this invention to provide an in-ear hearing device, which permits both automatic and regulated adaptation to protect a user's listening and audio experience, augmentation of that listening experience by reception of wearer-selected data streams, while protecting the wearer from unwanted decibel levels that might otherwise cause damage to their hearing both from the event and the audio augmentation signal stream.

It is a further object of this invention to provide a system, either alone or in connection with an in-ear hearing device, which incorporates a system to indicate the extent and nature of surrounding decibel levels and sound and correlates that to one or more databases which contain information to permit the selection of decibel levels which will minimize hearing loss and damage to the auditory system as the result of high decibel levels both as the result of the event and surrounding sound as well as the additional audio streams.

It is yet a further object of this invention to provide access to supplemental data streams consisting of audio and/or audio-video content, which augments an individual's experience and creates connectivity between the hearing device and other sound and media sources to permit the enhancement of the auditory experience and provide the ability of the wearer to personally control that experience.

It is yet a further object of this invention to permit the decibel correction and detection to occur either in connection with a related personal electronic device, a programmable set of criteria associated with the in ear hearing device or by way of a dedicated control system each of which can modulate and regulate the frequencies and decibel level delivered to and auditory experience of the user of the personal electronic device and the hearing device and permit the user to split the auditory aspect of the input data so as to have the event aspect received by one hearing device while the augmentation aspect is received by the other hearing device. This system may consist of a combination of applications in conjunction with mobile devices,

It is yet a further object of this invention to permit the wearer to create an overall augmented sensory experience substantially unique to the wearer by selectively accessing audiovisual and auditory signals, modulating the auditory signals to minimize hearing loss, and interacting with others within the social network to exchange data relative to the selectively accessed video and auditory signals.

It is another object of this invention to permit the user of the personal electronic device and others to share specific augmentation information between and with one another.

It is a further object of this invention to permit the demand for and delivery of a multiplicity of data streams on an individualized basis to participants at a live event so as to enhance the overall experience at the live event, while simultaneously providing auditory protection both from event derived decibel level and augmentation derived decibel levels (from external data stream). Such data streams may include a specifically and newly produced data stream specific to the event, team, etc, that the user may tap into as well as other data streams that are currently available such as commentary from an announcer.

It is a further aspect of this invention to provide a method for updating event information and experiences to members of the social network of people who are part of the system and/or own one of the hearing devices by communicating with an electronic device and undertaking the following steps: identifying an event, providing information about an augmentation signal or signals to enhance the event, delivering the information about the augmentation to others at the event and outside of the event by the first member of the social network, requesting a review of the information relating to the augmentation and, receiving the review of the information when it is available, using the received review information to either initiate additional augmentation action by a member of the social network, and processing ambient sound received at the programmable hearing aid to minimize hearing damage due to the event and the augmentation signal(s), thus permitting the sharing of information relative both to additional data streams and ambient sound.

It is a further aspect of this invention to provide a non-transitory computer readable medium for storing computer code executable by a processor incorporated in an electronic device for updating audio processing of a programmable hearing device in communication with the electronic device and updating information relative to a new or augmented data stream. The computer readable medium includes at least computer code for identifying an event, providing information about the augmentation situation, signal or signals to enhance the event, providing information about the augmentation situation to other members of the social network, requesting a review of the augmentation situation by the other members of the social network, processing a review of the information received from the other members and using the received review information to either initiate augmentation action by another member of the social network and/or update the augmentation audio and/or video signals and implement protective aspects of the programmable hearing aid or the member routing, and processing ambient sound received at the programmable hearing device in accordance with the received and reviewed information to minimize hearing damage due to the event and the augmentation signal(s).

It is yet a further aspect of this invention to provide a participant in a live event either or both a real time and/or historical audio/video data stream to the personal electronic device user and/or hearing device wearer to augment the live event while simultaneously providing information as to specific decibel levels at which the use will incur hearing damage, thus permitting them to implement corrective hearing device action or take other corrective actions to reduce the hearing loss effect of both the event and the augmentation signals while enjoying an augmented audio/video experience

It is another aspect of this invention to generate ad related content to the participant, either of a generalize nature or pursuant to a participant profile.

It is another aspect of this invention to delivery coupons and other similar buying incentives to the participant to permit them to obtain both event related merchandise and non-event merchandise using provider delivered “shopping carts”, “checkouts” and payment options.

It is yet another aspect of this invention to permit the participant to select alternative data streams to supplement the event at such time as there is a recess or intermission in the event.

It is another aspect of this invention to provide a controlled augmentation signal system which requires the event participant to register to obtain the augmentation and either pay for the augmentation or otherwise participate with the provider of the augmentation by giving the provider certain participant information and demographic data to use in the provider's database. This database may be used, illustratively, for incentives, mobile coupons, populating algorithms to obtain maximum pinpointing on ads and other informational and promotional activities, permitting the participant to obtain free use of the augmentation in exchange for demographic data and having the participant act as an advocate of the data and event within their social network.

It is a further aspect of this invention to provide the event participant with additional information unrelated to the event, either in response to specific participant requests or of a generalized nature, which would be of interest to virtually all participants.

It is yet another aspect of this invention to provide individuals who are not participants at an event sufficient data and audio information to make them feel involved and participating vicariously in the event so as to be able to deliver event related merchandise offerings to the non-participating individuals for purchase by them. This may include but is not limited to inside-out data streams which provide audio feeds to non-participant individuals from the live event (i.e. the sound of the football being punted or the hot dog seller's call)—to allow them to feel like they are at the event. This is particularly beneficial in situations in which there is an oversold stadium event (such as the Olympics, Champions League Finals, etc.), where large monitors are set up outside of a stadium. In this instance those non-stadium participants may obtain the audio benefits of the in-stadium audio/video, which can be conveyed to them through the in ear hearing device and related systems, applications and communication devices.

It is a further aspect of this invention to provide virtual event augmentation signals at an event to permit a participant to virtually “play along” with the actual team members and thereby become a virtual participant in the event, such as, by way of example only, a “virtual instant replay” which the participant can modify to run a different, event scenario or other such hypothetical result that did not actually occur, including a virtual representation of what could have happened had another configuration of players been on the field, by way of accessing data of similar occurrences at past events/matches.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 shows a representative hearing device in accordance with the described embodiments.

FIG. 2 is a flowchart detailing a process in accordance with the described embodiments.

FIG. 3 is a flowchart illustrating a system in accordance with the described embodiments.

FIG. 4 is a representative computing system, processor and flowchart with illustrative, high level descriptors for employing an external processing, personal electronic device in a social network environment, in accordance with the described embodiments.

FIG. 5 is a representative, illustrative personal electronic device in a social network environment with illustrative augmentation, in accordance with the described embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

In the discussion that follows, terms such as in ear device, hearing device, hearing device system or personal electronic device may be employed to refer to sample implementations of the present invention. However, no particular limitation should be inferred in scope or applicability of the invention from the use of this term.

Certain terminology may be used in the following description for convenience only and is not limiting. The words “lower” and “upper” and “top” and “bottom” designate directions only and are used in conjunction with such drawings as may be included to fully describe the invention. The terminology includes the above words specifically mentioned, derivatives thereof and words of similar import.

Where a term is provided in the singular, the inventors also contemplate aspects of the invention described by the plural of that term. As used in this specification and in any claims, the singular forms “a”, “an”, and “the” include plural references unless the context clearly dictates otherwise, e.g. “a derivative work”. Thus, for example, a reference to “a method” includes one or more methods, and/or steps of the type described therein and/or which will become apparent to those persons skilled in the art upon reading this disclosure.

Unless defined otherwise, all technical, legal, copyright related and scientific terms used herein have the same meaning or meanings as commonly understood by one of ordinary skill in the art to which this invention belongs. Although any methods and materials similar or equivalent to those described herein can be used in the practice or testing of the present invention, the preferred methods, constructs and materials are described herein. All publications mentioned herein, whether in the text or by way of numerical designation, are incorporated herein by reference in their entirety. Where there are discrepancies in terms and definitions used by reference, the terms used in this application shall have the definitions given herein.

The term “variation” of an invention includes any embodiment of the invention, unless expressly specified otherwise.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise.

The terms “a”, “an” and “the” mean “one or more”, unless expressly specified otherwise. The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a hearing-damaging location” describes both “the data represents only the hearing-damaging location” and “the data represents a hearing-damaging location and the data also represents something else, such as an event or occurrence”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, and/or “e.g.” and like terms means “for example”, and thus does not limit the term or phrase it explains. For example, in the sentence “the microprocessor sends data (e.g., instructions, a data structure)”, the term “e.g.” explains that “instructions” are an example of “data” that the system may send, and also explains that “a data structure” is an example of “data” that the system may send. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example, the functions of one or more processors presented in the figures may be provided by a single shared processor or multiple processors. Use of the term “processor” should not be construed to refer exclusively to hardware capable of executing software.

Illustrative embodiments may comprise microprocessor and/or digital signal processor (DSP) hardware, read-only memory (ROM) for storing non-transitory software performing the operations discussed below, and random access memory (RAM) for storing results. Very large scale integration (VLSI) hardware embodiments, as well as custom VLSI circuitry in combination with a general purpose DSP circuit, may also be provided.

A “processor” includes one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures), which may be read by a computer, a processor or a like device and includes non-transitory computer-readable medium. Such a medium may take many forms, including but not limited to, non-volatile media, volatile media, and transmission media.

This detailed description makes reference to certain exemplary embodiments of the invention and various aspect of the invention. Other embodiments may be employed, and aspects described or not described, and structural and electrical changes may be made without departing from the spirit or scope of the present invention.

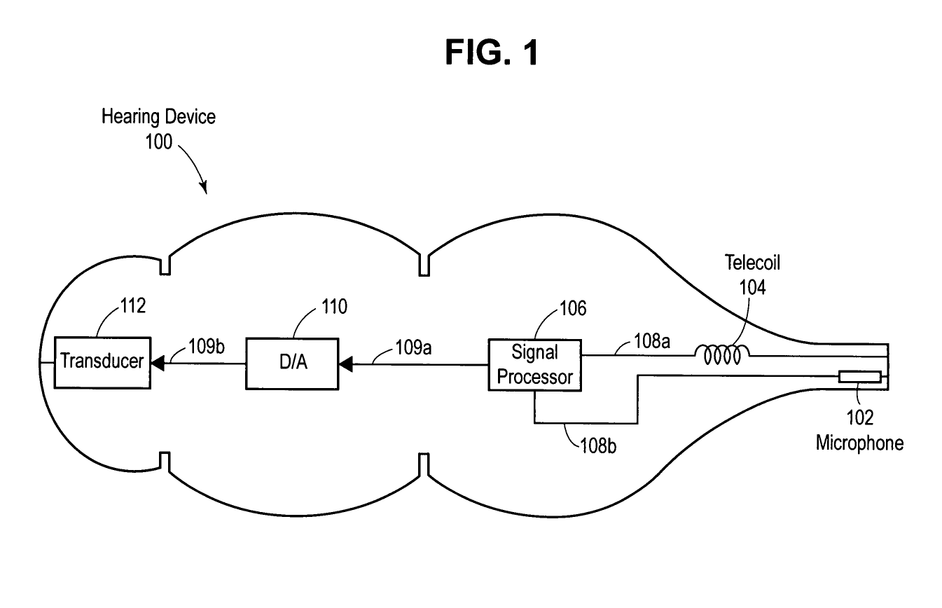

FIG. 1 is a block schematic showing a hearing device 100 in accordance with the described embodiments. Hearing device 100 can include at least audio sensor 102 arranged to detect acoustic energy that can take the form of sound. The hearing device 100 may also employ a tele-coil 104 to similarly detect acoustic energy that can take the form of sound. In one embodiment, audio sensor 102 can take the form of one or more microphones 102 connected to an input node of audio signal processing circuitry 106. Similarly tele-coil 104 can be connected to an input node of the audio signal processing circuitry 106. Microphone 102 can mechanically respond to sound waves impinging on the surface of a membrane (not shown). The vibrating membrane can interact with a transducer (not shown) to create electrical signal 108A that is analogous (i.e., the analog) to the detected sound waves. Alternatively, the tele-coil 104 can provide an analog signal to an input node of audio signal 108B processing circuitry 106.

The electrical analog signal 108A or 108B can be passed to audio processing circuitry 106 for processing. While the audio processing circuitry 106 can be totally analog in nature, in other embodiments, the audio processing circuitry 106 can have some components that are analog while other components are digital. With that explanation and without loss of generality, the audio processing circuitry 106, will, for purpose of simplicity, be considered as being fully digital in nature. The digital audio processing circuitry 106 can include analog to digital (A/D) converter unit (not shown) arranged to receive analog signal 108A generated by microphone 102 and convert the analog signal 108 into a digital signal 109 using any suitable digitization process

An output node of the A/D converter unit can be connected to the digital signal processor 106. The digital signal processor 106 can include at least additional signal processing circuits (not shown) for filtering, compressing, modulating, decreasing and/or amplifying input digital signal 106 to form output digital signal 109A at an output node of digital signal processor 106 that can, in turn, be connected to an input node of a digital/analog (D/A) converter 110. The digital signal processor 106 can also include additional signal processing circuits, which can compare the input digital signal 109 to other data, including its magnitude as a function of time, or as a function of other criteria and adapt, modify, decrease or otherwise alter the input digital signal 109 to form output digital signal 109A

D/A converter 110 can convert digital signal 109A into a corresponding analog signal 109B at an output node of D/A converter 110 that can be connected to and be used to drive output transducer 112. It should be noted, however, that in an alternative embodiment, digital signal processor 106 can be configured in such a way to drive output transducer 112 directly without requiring D/A converter

It should also be noted that output transducer 112 can take many forms depending upon the nature of hearing aid 100. For example, in one embodiment, output transducer 112 can take the form of an acoustic transducer arranged to provide acoustic output in the form of sound waves. The acoustic output can then be transmitted in a conventional manner to the hearing aid user's auditory system—same as above

In one embodiment, digital signal processor 106 can be programmable by which it is meant that the audio processing carried out by digital signal processor 106 can be widely varied. For example, digital signal processor 106 can be programmed according to a decibel level profile that can include a plurality of settings each of which can alter a corresponding audio processing operation. The settings can include various decibel level curves (along the lines of a buffer or data storage system), comparators, controls, filtering such as notch, clipping or band pass filtering and the like. Moreover, the digital signal processor 106 can incorporate a set of rules, which relate to hearing-damaging situations and locations. In this way, hearing device 100 can adapt its signal processing to a wide number of variables such as the environmental (i.e., ambient) noise level, user provided changes to parameters and so on

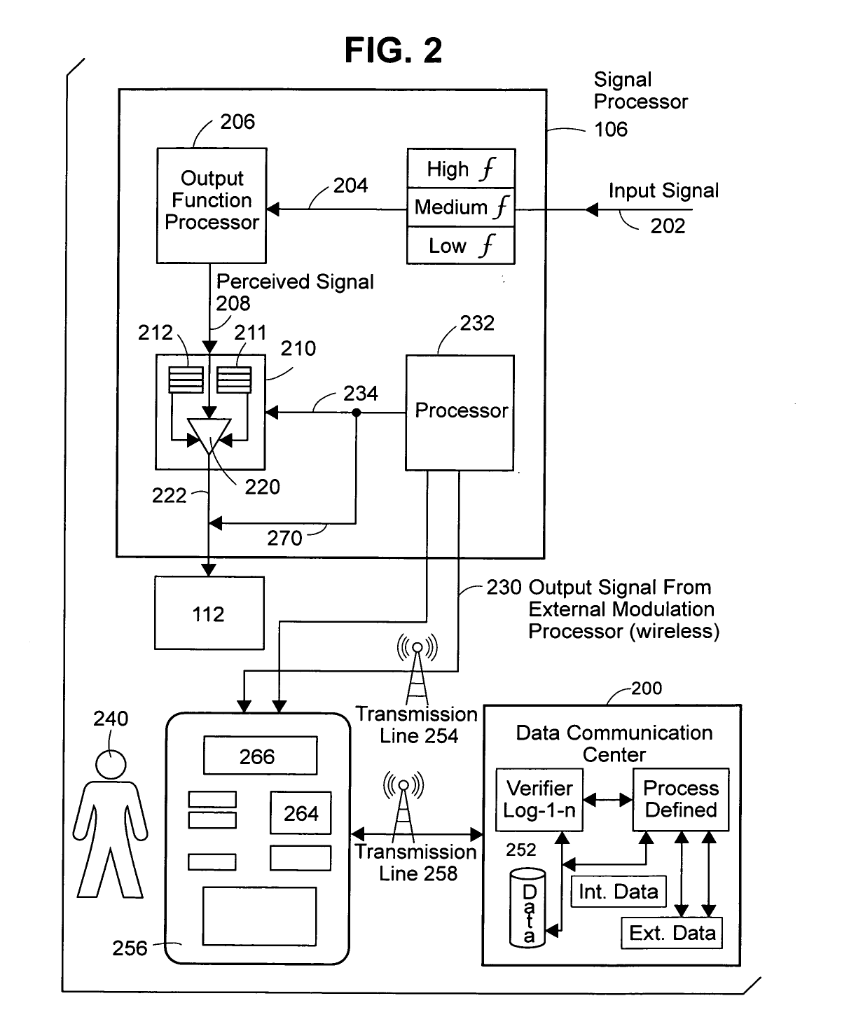

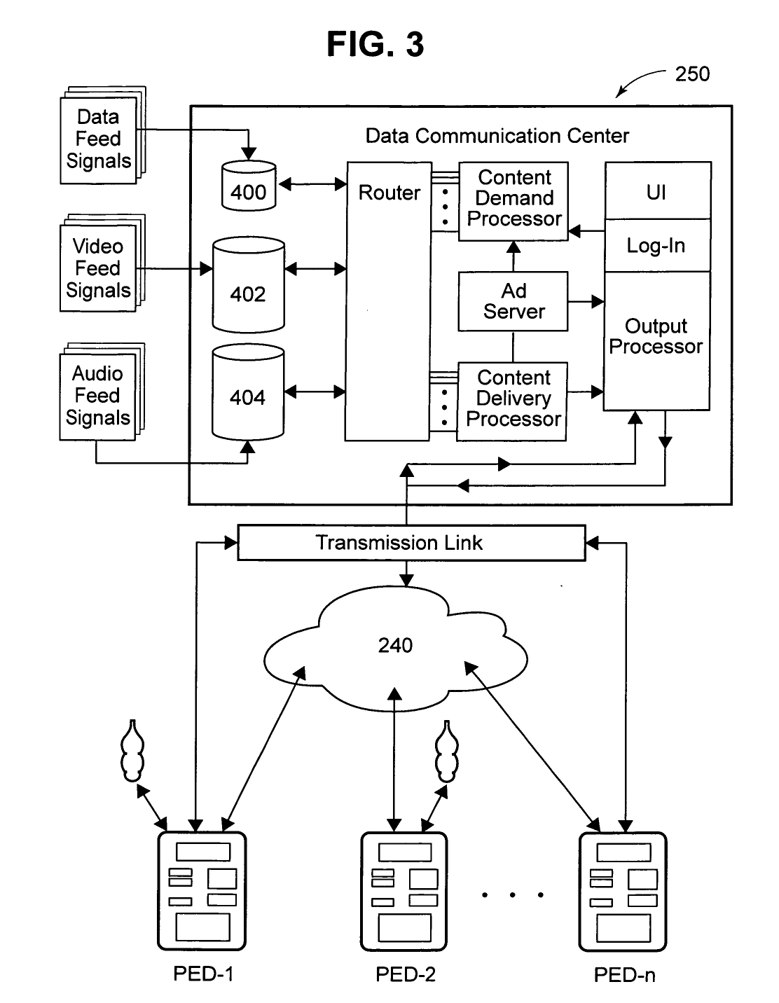

FIG. 2 and FIG. 3 are flowcharts detailing a hearing device and a system in accordance with the described embodiments. An input signal 202 is passed to the frequency band analyzer circuitry 203 of the digital signal processor 106. The frequency band analyzer circuitry 203 may permit the determination of the bandwidths and frequency distribution of the input signal into a distributive function signal 204 representative of the high, medium and low frequencies. The distributed function signal 204 is analyzed by an output function processor 206, which determines the decibel level and generates a perceived signal 208. The perceived signal 208 is transmitted to an internal modulation processor 210. The internal modulation processor 210 may incorporate a non-transitory, preprogrammed data array 211 with decibel level indicators 212 and a set of rules 214 as to the effect of each of the decibel level indicators 212

The perceived signal 208 is processed by the internal modulation processor 210 to determine whether it corresponds to any of the decibel level indicators 212 and, if so, whether to apply one or more of the rules 214 to the perceived signal 208. By way of example, the internal modulation processor 210 may incorporate a comparator circuit 220 that processes the perceived signal 208 and compares it to the array 211 of decibel level indicators to derive a differential between the perceived signal 208 and the closest decibel level indicator 212. Once the comparator circuit 220 has derived a differential, it can, using a lookup table, determine the rule 214 which should be applied in order to modulate the perceived signal 208 and bring it within the confines of the rule 214

If the perceived signal 208 is modulated in accordance with one of the rules 214, an output audio signal 222 is delivered via the comparator circuit 220 to the transmitter 110. Alternatively if the perceived signal 208 is not modulated then the input signal 202 may be directly delivered to the transducer 112. As can be appreciated by the above illustrative example, the internal modulation processor 210 can provide automatic auditory protection to the hearing aid where in the event of a determination of the presence of a hearing-damaging situation. The internal modulation processor 210 may also perform its modulation as a function of decibels per unit time in order to provide a running aggregate for protective purposes. Alternatively it can have an acceleration function analyzer to determine the presence of a rapid increment of decibels analogous to an instantaneous peak in sound, such as a siren or other sharp and immediate noise. A further alternative would be to employ an input signal 202 from an external modulation processor as is more fully shown and described in relationship to FIG. 3

FIG. 2 and FIG. 3 further exemplify a representative communication and system structure 200 in accordance with one illustrative embodiment of an implementation of the invention. The communication system 200 may be employed in any number of events ranging from football games and motor racing events to Olympic events to tennis matches and beyond. The system 200 is generally designed to accommodate numerous members of the public who are attending a live event or who may be attending a “virtual live” event such as a simulcast of a sporting event

The system 200 is generally comprised of a data communication center 250 which is capable of receiving requests for augmentation data streams 251 from attending, requesting members 240 of the public present at the event, processing those requests to permit the requesting member 240 to gain access to the requested augmentation data streams 251 and providing access to the requested augmentation data streams by, illustratively, transmitting the data streams 251 to the requesting member 240 or providing the requesting member 240 access to a secure site where they can stream the requested augmentation data streams 251 or otherwise delivering the augmentation data streams 251, all preferably in an auditory modulated manner to prevent hearing damage.

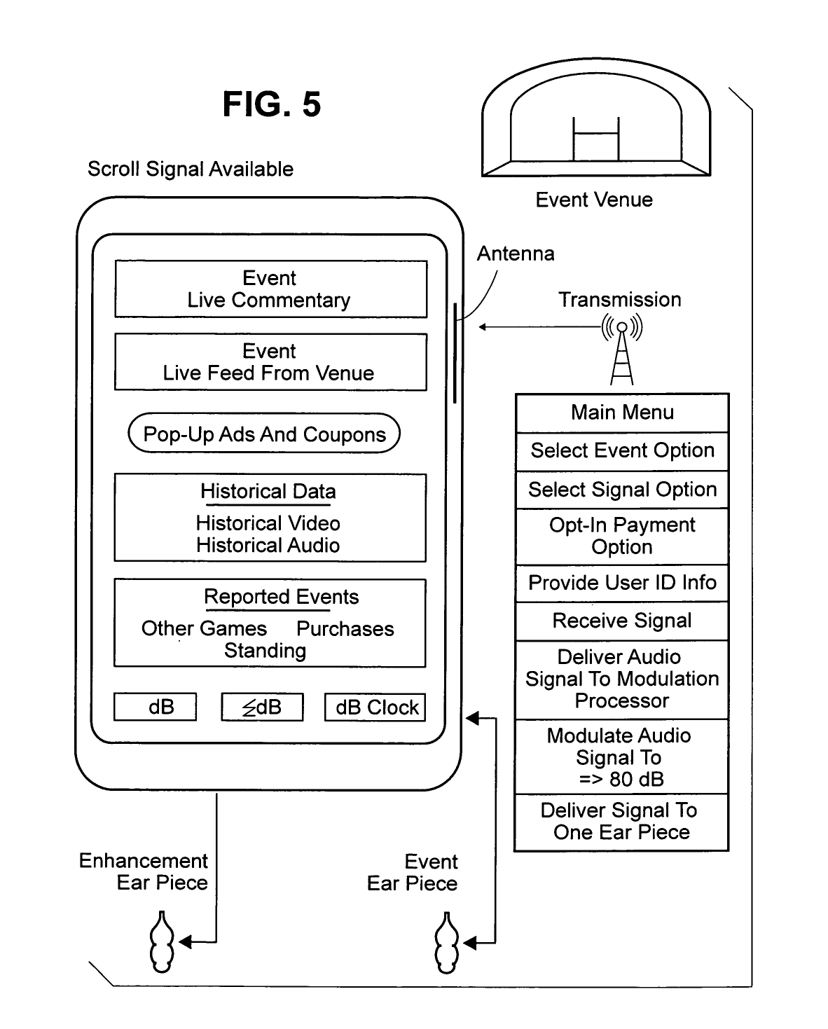

As illustrated in FIG. 2 and FIG. 3, the data communication center 250 may include a verification/log-in processor 252 which can receive a signal 254 from a personal electronic device 256 through a low-power transmission link 258. The signal 254 may initiate an authentication process through the verification/log-in processor 252 to permit the requesting member 240 to access a menu 260 of available augmentation data streams 251 that are available for the particular event being attended. Looking also at FIG. 5, typically, the requesting member 240 will not be charged for access to the menu 260. In an illustrative embodiment, the menu 260 may identify live feed augmentation streams 251 from the event, commentary on the event, historical information relating to the teams, participants or other players who are being viewed at the event or other auditory, visual and contextual material, depending on the nature of the event. Additionally, some of the augmentation data streams 251 may originate and be available through, by way of example, only the sponsoring league, such as the NFL in conjunction with the teams that are playing in a particular football game while other augmentation data streams 251 may originate with broadcasters, commentators or independent data sources. It is noted that the creation of the systems may lead to new positions within these organizations (such as the NFL or a particular team within it) to produce and curate specific augmented content for the specific event the user is attending (in order to ensure its quality and that sensitive “on field” information does not get disseminated or revealed). Each such augmentation data stream 251 is within the scope of this invention and the examples are not meant to limit the applicability of the invention either to the forms of augmentation data streams 251 or the nature and type of events to which the system may be applied. Moreover, the augmentation data streams 251 may be visual, auditory or audio/visual in nature as well as contextual and/or historical.

Referring again to FIGS. 2-4, once the requesting member 240 has selected the augmentation data streams 251 which they wish to access during the event, the requesting member 240 can either pay for the augmentation data steams 251 via a secure link, such as PayPal®, or the requesting member 240 can set up an account or may have already set up an account 262 so that the cost of the augmentation data streams 251 can be automatically billed. Alternatively, the requesting member 240 may be allowed to obtain certain augmentation data streams 251 without payment in exchange for the requesting member 240 providing user information, agreeing to view selected ads, buying the associated hardware, as part of a “package,” or other inducements to permit the creation of a requesting member 240 profile which may form part of a data base.

Once the requesting member 240 has secured access to the requested augmentation data streams 251, the data communication center 250 processes the request and transmits the augmentation data steams 251 or otherwise provides access to the data streams 251. The data communication center 250 may, illustratively, employ cellular data links, an intra-net system, the Internet, hardwired access, specialized event site wiring or transmission protocols or devices or other content delivery and transmission mechanisms, all of which are within the overall scope of the embodiments of this invention.

Referring to FIGS. 2-5, the augmentation data streams 251 are received by the personal electronic device 256 and processed to permit both audio 264 and visual 266 augmentation data streams 251 to be received by the personal electronic device 256. The visual portion 266 of the augmentation data steam 251 may be displayed on the screen of the individual's personal electronic device 256. It may be advantageous to provide to a requesting member 240 an hardware application burned into a chip or mobile application, both of which are within the scope of this invention, specific to the particular event. The application can generally accompany the augmentation data streams 251 and be uploaded to create a graphical user interface (GUI) which is event specific and can be customized by the requesting member 240 to permit them, by way of illustration, to select which augmentation data steam 251 will be the top layer of the video display, how the member 240 will browse between the data streams, what language the audio 264 portion will be in, etc. FIG. 5 illustrates a typical representative user interface on a personal electronic device 256.

The audio portion 264 of the augmentation data steams 251 can be processed to generate an output signal 230 A that is representative of the audio portion 264 and carries the audio information in the augmentation data steams 251. The output signal 230 A is transmitted to a processor 232 in the signal processor 106 of one hearing aid 100 A. The processor 232 in the hearing device 100 A generates a signal 234 in response to the output signal 230 A which is representative of the amplitude and frequency distribution of the of the audio portion 264 of the augmentation data streams 251 and transmits that signal 234 to the internal modulation processor 210. The signal 234 is processed by the internal modulation processor 210 to determine whether it corresponds to any of the decibel level indicators 212 and, if so, whether to apply one or more of the rules 214 to the signal 234. By way of example, the internal modulation processor 210 may incorporate the comparator circuit 220 that processes the signal 234 and compares it to the array 211 of decibel level indicators to derive a differential between the signal 234 and the closest decibel level indicator 212. Once the comparator circuit 220 has derived a differential, it can, using a lookup table, determine the rule 214 which should be applied in order to modulate the signal 234 and bring it within the confines of the rule 214.

Additionally, the signal 234 contains an audio augmentation stream identifier 270, which is capable of being sensed by cut-off sensor 272. Cut-off sensor 272 may be advantageously implemented either by circuitry, software or both. The cut-off sensor 272 transmits an output signal 274 to an over-ride indicator switch 276 which advises the requesting member 240 that the audio augmentation stream has been modulated to avoid hearing damage and is available for delivery to the hearing aid (device) 100 A. Upon receipt of the advice from the over-ride indicator switch 276, the requesting member 240 may activate the circuitry and software associated with the over-ride indicator switch 276 and select to receive the signal 234 and exclude the reception of “live” event audio to the hearing aid 100 A. The requesting member 240 may toggle the over-ride indicator switch 276 back and forth so as to activate and de-activate the signal 234 to hearing device 100 A and may also elect to deliver the signal to both hearing devices 100 through equalization and override circuitry in the hearing device (not shown). This action may be performed by use of the application or other elements of the system, and may be a combination of hardware and software, including a mobile application for use with a participant's portable electronic device.

FIGS. 3-5 are flowcharts and graphical representations illustrating a system and various components of a system in accordance with the described embodiments and its use in a social network environment. The data communication center 250 may be comprised of a series of data bases, illustratively shown as contextual data feed data base 400, video feed data base 402 and audio data base 404. The respective data bases 400, 402 and 404 may obtain data from one or more external signals and/or one or more signals that are internal to the event. Thus, by way example, data feed signal 406 may be comprised of n-different data signals 406 (1) through 406 (n) which, in the context of a football game, can be historical data on each team, each of its members, the coaching staff, etc. (external data) and data as to the nature and success of the various plays that have occurred during the particular game (internal data). Similarly, video feed signal 408 may be comprised of n-different data signals 408 (1) through 408 (n) which, illustratively, can be highlights of other games that are going on simultaneously, similar plays and strategies that have been run in other games by the same team, the opposing team, or other teams, etc. (external video) and video from unique additional camera locations that are generally not available in a broadcast context or letting the requesting member 240 select the specific camera which he wishes to access to augment their enjoyment of the event (internal video).

The personal electronic device 256 may also include an authentication processor (not shown) to permit authentication related tasks, such as processing a user code entered by the requesting member 240 where they have previously established an account or transmitting authentication and payment information to allow the requesting member 240 to access to the augmentation data streams 251. The authentication processor may be implemented in circuitry, software or a combination of hardware and software. When a requesting member 240 desires to purchase the delivery of augmentation data streams 251 to the personal electronic device 256, for viewing on the device and delivery to the hearing device 100 or 100 A, the requesting member 240 logs in through the GUI and, upon validation by a content demand processor 502 generally located at the data communication center 250, the content demand processor 502 issues an authentication decision signal 504 to the requesting member 240. The authentication decision signal 504 issued to the authentication processor can also be designed to handle levels of service such that the requesting member 240 may only be able to access specific augmentation data streams 251 and not other streams. The authentication decision signal 504 is also transmitted to a router 506 to indicate what specific augmentation data streams the requesting member 240 can receive through the personal electronic device 256. While the use of the authentication processor is generally described as something, which occurs at the event, it may be done prior to the event, remotely in anticipation of the event, or at the time of entry into the event facility when tickets are presented. The implementation may also be encoded into the tickets so that the personal electronic device 256 is immediately capable of receiving the desired augmentation data streams 251 upon presentment and verification of the tickets. The augmentation data streams 251 may also be sold in conjunction with the tickets at the time of purchase of the tickets, illustratively at a promotional discount or as a means to obtain personal identification and demographic data related to the purchaser.

The router 506 assembles each group of requested augmentation data streams 251 and transmits them to a content delivery processor 508. While the current description of one embodiment of the invention depicts each requesting member 240 selecting from the menu 260 of augmentation data steams 251, it is similarly understood that the scope of the invention is such that the menu 260 could comprise groups of augmentation data streams 251 bundled together, so as to reduce the processing required to deliver individually selected streams 251. The content delivery processor 508 transmits the augmentation data steams 251 to the personal electronic device 256 of each of the requesting members 240. The augmentation data streams 251 that are being transmitted from the content delivery processor 508 to each of the personal electronic devices 256 may generally be organized in the form of digital packets.

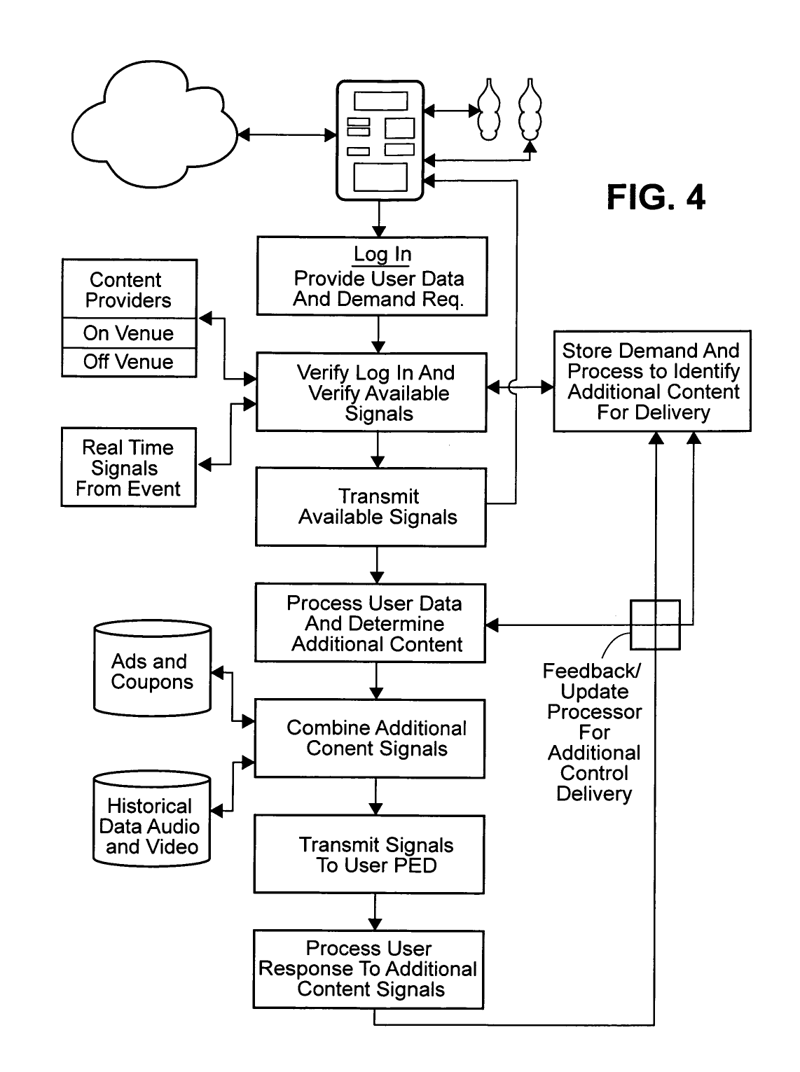

While numerous specific manners of delivery implementation may be used now and in the future to achieve the objective of the instant invention, one advantageous manner of delivery of the information packets is to employ an MPEG-4 augmentation data stream 251 for the video content and a second packet which includes any non-video related augmentation audio steam. As can be seen in illustrative form in FIGS. 3-4, an ad server 510 is functionally associated with the content demand processor 502 and the content delivery processor 508 to deliver ad content to each of the requesting members 240. This ad content may be delivered through a third packet which can include either generalized advertisements which would be distributed to all requesting members 240 at a specific event or individualized ad content pursuant to requesting member profiles which may be organized in demographic blocks and correlated to personal identification information which the requesting member had provided. Additionally, ad server 510 can deliver coupons and other incentives that can be (but do not necessary have to be) event specific and permit the requesting member 240 to obtain them immediately at the event or have them delivered to the person at home. In accordance with established protocols, each of the packets of data should include sufficient identification data in the header to permit the personal electronic device 256 to confirm that it is the correct device and indicate what specific type of content the packet holds such that the personal electronic device can adequately process each data packet.

FIG. 2 and FIG. 3, when viewed together, illustrate an embodiment of the invention where the data packets are delivered to each of a series of n (?)-personal electronic devices 256 (1) through 256 (n). The transmission is generally bi-directional to permit the requesting members 240 to change their requests during the event and to obtain more or fewer augmentation data streams 251. As is illustrated in FIG. 5, the video portion of the augmentation data stream 251 is provided to the screen of the personal electronic device 256 and may be viewed by the requesting member 240 in any of a number of fashions. The audio portion of the augmentation data stream 251 may be processed and modulated as set forth hereinbefore. Advantageously, the various personal electronic devices 256 are also generally capable of communicating with others both within and without a social network 290. Where other members of a social network are also attending an event, the requesting members 240 can exchange information obtained (but not the streams themselves) from the augmentation data steams 251 with each other and thereby alert one another to informative situations which can thereby result in other members of a social network virally acquiring other augmentation data streams that they had not previously thought to obtain and also identify which streams are most popular within a given event. As can also be seen through FIG. 3, if there are individuals at an event who do not have hearing devices, but are still within a social network, they can obtain information from others members at the event as to the level of noise and seek to reduce damage by either acquiring hearing devices at the event venue or taking other protective measures to minimize hearing loss. It is also a part of this invention that a gratuitous audio/visual augmentation data stream 251 be provided at event venues to provide requesting members 240 who otherwise obtain augmentation data streams to receive a decibel level data stream which gives them relevant auditory data to permit individuals to minimize their hearing loss by taking appropriate action.

The various aspects, embodiments, implementations or features of the described embodiments can be used separately or in any combination. Various aspects of the described embodiments can be implemented by software, hardware or a combination of hardware and software. The computer readable medium is any data storage device that can store data, which can thereafter be read by a computer system. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A mobile system for providing auditory data to a user comprising:
a. an in-ear hearing device capable of receiving external sounds and at least one external stream of audio data;
b. a mobile device receiver to receive a common wireless data stream, said data stream comprised of audio and/or audio visual data;
c. a graphical display associated with said mobile device to present at least a portion of a graphical user interface;
d. a computing device including a memory and non-transitory computer readable medium for storing computer code executable by a processor incorporated in the computing device;
e. a processor in communication with the receiver to obtain and process at least one data stream in response to a data stream selection by the user; and,
f. a data transmitter in communication with the processor to transmit the selected audio data stream to the in-ear hearing device.

2. The mobile system of claim 1 further comprising:
a. a processor for sensing an ambient sound representative input signal and communicating with the computing device;
b. computer code for requesting a review of the sensed ambient sound auditory representative input signal;
c. computer code for receiving the review of the sensed ambient auditory representative input signal;
d. a comparator for comparing the sensed ambient auditory representative input signal with a predetermined compilation of potential input signals;
e. computer code for displaying on the graphical display the result of the comparison; and,
f. a transmitter in communication with the processor to modulate the sensed ambient input signal to the in-ear hearing device to a determined input signal level.

3. The mobile system of claim 1 wherein:
a. the processor in communication with the receiver is capable of obtaining and processing multiple data streams in response to data stream selections by the user.

4. The mobile system of claim 1 wherein:
a. the processor in communication with the receiver obtains and processes at least one video data stream in response to a data stream selection by the user and delivers that video data stream to the mobile device graphical interface.

5. A method for providing auditory data to a mobile device user comprising:
a. selecting by a user at least one external stream of audio data for transmission to an in-ear hearing device;
b. receiving at least one common wireless data stream by a receiver, said data stream comprised of audio and/or audio visual data;
c. graphically displaying a representation of the audio data on at least a portion of a graphical user interface;
d. processing non-transitory computer readable, stored computer code executable by a processor incorporated in a computing device;
e. communicating with the receiver to obtain and deliver to the processor the user selection;
e. processing at least one data stream in response to a data stream selection by the user;
f. transmitting to the processor the selected audio data stream to the in-ear hearing device; and,
g. receiving at least one external stream of audio data by the in-ear hearing device;

6. The method of claim 5 further comprising:
a. sensing an ambient sound representative input signal and communicating with the computing device;
b. requesting a review of the sensed ambient sound auditory representative input signal;
c. receiving the review of the sensed ambient auditory representative input signal;
d. comparing the sensed ambient auditory representative input signal with a predetermined compilation of potential input signals;
e. displaying on the graphical display the result of the comparison; and,
f. transmitting a modulation instruction which is a function of the sensed ambient input signal to the in-ear hearing device to maintain a determined input signal level.

7. The method of claim 5 further comprising:
a. obtaining and processing multiple data streams in response to data stream selections by the user.

8. The method of claim 5 further comprising:
a. obtaining and processing at least one video data stream in response to a data stream selection by the user; and
b. delivering the video data stream to the mobile device graphical interface.

9. The mobile system of claim 1 further comprising:
a. advertising delivery means to provide advertising content to a user.

10. The mobile system of claim 9 wherein:
a. the advertising delivery means delivers advertising content in accordance with user profiles.
